(19) United States
(12) Patent Application Publication
(10) Pub. No.: US 2010/0244510 A1
(43) Pub. Date: Sep. 30, 2010

(54) DISPLACEABLE HEAD RESTRAINT

(76) Inventor: Andreas Schmitz, Burscheid (DE)

Correspondence Address: BUTZEL LONG;IP DOCKETING DEPT, 350 SOUTH MAIN STREET, SUITE 300, ANN ARBOR, MI, 48104, US

(21) Appl. No.: 12/097,536

(22) PCT Filed: Dec. 21, 2006
(86) PCT No.: PCT/EP2006/012363

§ 371 Date: Jun. 15, 2010

(30) Foreign Application Priority Data
Jan. 6, 2006 (DE) 10 2006 001 143.0

(51) Int. Cl. B60N 2/427

(52) U.S. Cl. 297/216.12

(57) ABSTRACT

A displaceable head restraint for a seat has a padded portion that is displaceable relative to a base part of the head restraint from a nominal position to a safety position using a driving mechanism and returnable to the nominal position using a restoring device. The restoring device includes a handle releasably connected to a receiver plate, and the receiver plate is positioned on a fixed portion of the base part. A cable having one end attached to the handle and an opposed end connected to a rotatable member is disposed between the padded portion and the base part. Application of a force on the handle that is opposed to a direction of displacement of the padded portion between the nominal position and the safety position rotates the rotatable member to return the padded portion to the nominal position.

### CROSS REFERENCE TO RELATED APPLICATIONS

The present application is National Stage filing of International Application No. PCT/EP2006/012363, filed on Dec. 21, 2006, titled “Headrest, Especially for a Motor Vehicle” which claims priority to German Patent Application No. DE 10 2006 001 143.0, filed Jan. 6, 2006, the entire disclosures of which are incorporated herein by reference.

### BACKGROUND

The present disclosure relates to a head restraint for a seat, and more specifically to a displaceable head restraint for use in a vehicle seat.

A head restraint for a vehicle, such as a motor vehicle, includes a padded portion and a base interconnecting the padded portion with a seatback. The head restraint may be displaceable as a result of an external force, such as due to a collision. An example of a displaceable head restraint is illustrated in German patent application DE 102 15 137 A1. This head restraint includes a base part connected to the backrest via holding rods and a padded sub-section which may be displaced relative thereto in the forward direction (X-direction of the vehicle) toward the head of the seat occupant. The displacement of the sub-section takes place as a result of a force releasing a locking device via a driving mechanism. A probe may be inserted from the rear face of the base part in the direction of the sub-section, and the sub-section may be returned from its safety position to its normal operating position. The probe generates a force which acts counter to the direction of movement of the sub-section.

While this type of head restraint works, it requires a specific tool to return the head restraint to a nominal operating position and the tool must always be available. Otherwise, a vehicle which is still roadworthy after an accident would require servicing to return the head restraint from the safety position, to the nominal operating position.

Thus there is a need in the art for a head restraint which may be moved from a safety position to a nominal operating position without the use of a tool.

### SUMMARY

Accordingly, the present disclosure relates to a displaceable head restraint for a vehicle. The head restraint includes a padded portion that is displaceable relative to a base part of the head restraint from a nominal position to a safety position using a driving mechanism and returnable to the nominal position using a restoring device. The restoring device includes a handle releasably connected to a receiver plate, and the receiver plate is positioned on a fixed portion of the base part. A cable having one end attached to the handle and an opposed end connected to a rotatable member is disposed between the padded portion and the base part. Application of a force on the handle that is opposed to a direction of displacement of the padded portion between the nominal position and the safety position, rotates the rotatable member to return the padded portion to the nominal position.

Other features and advantages of the present disclosure will be readily appreciated, as the same becomes better understood in view of the subsequent description taken in conjunction with the accompanying drawings.

### BRIEF DESCRIPTION OF THE DRAWINGS

FIG. 1 is a side view of a motor vehicle seat having a head restraint according to the disclosure.

FIG. 2a is a perspective view of the driving mechanism for the head restraint of FIG. 1 in the operating position, according to the disclosure.

FIG. 2b is a perspective view of the driving mechanism of FIG. 2A in the safety position of the head restraint, according to the disclosure.

FIG. 3 is a rear view of another example of a head restraint according to the disclosure.

FIG. 4a is a plan view showing the restoring device for the head restraint of FIG. 3 in a first position.

FIG. 4b is a plan view showing the restoring device for the head restraint of FIG. 3 in a second position.

FIG. 4c is a plan view showing the restoring device for the head restraint of FIG. 3 in a third position.

### DESCRIPTION

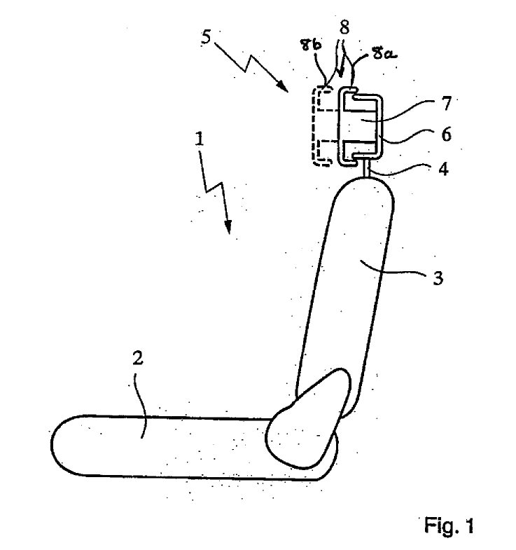

Referring to FIG. 1, a vehicle seat 1 includes a seat part 2 and a backrest 3 having a head restraint 5. The head restraint 5 is connected via holding rods 4 to the backrest 3. In this example, the head restraint 5 is height-adjustable. The head restraint 5 includes a base part 6 connected to the holding rods 4, and a padded sub-section 8. The padded sub-section 8 may be displaced from an operating position, as shown at 8a in the direction of the head of a seat occupant, into a safety position as shown at 8b using a driving mechanism 7. An example of a driving mechanism is described in commonly assigned patent specification DE 10 2004 016 474 B3.

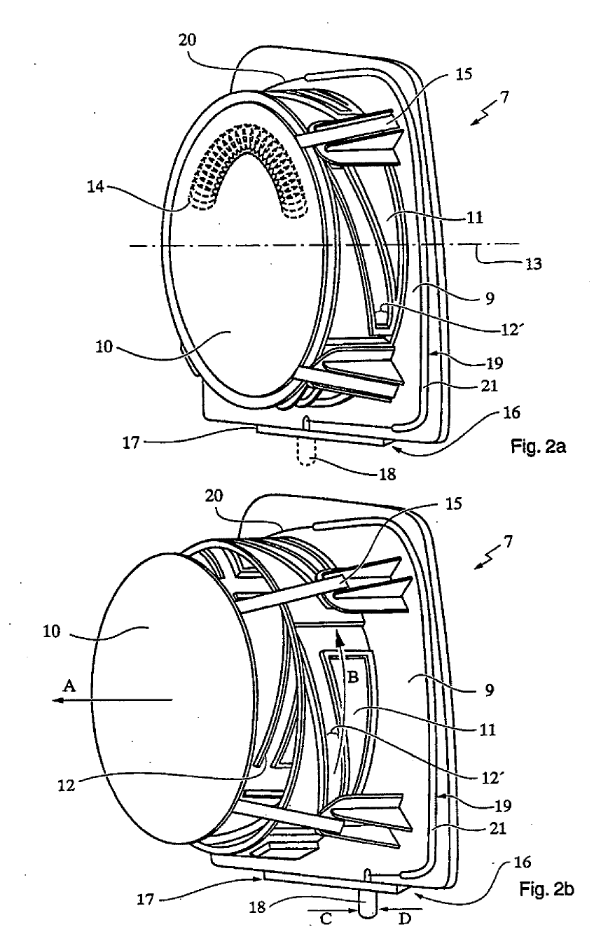

Referring to FIG. 2, the driving mechanism 7 include a first member 9 fixedly connected to the base part 6 and a second member 10 that is displaceable with respect to the first fixed member. The second displaceable member is connected to the padded sub-section 8. The second displaceable member 10 may be displaceably mounted on the first fixed member 9 via a sliding guide 15 which is displaceable in the direction of arrow A. A third rotatable member 11 may be rotatably mounted between the first fixed member 9 and a second displaceable member 10. For example, the third rotatable member 11 may include a guide slot, as shown at area 12, 12′ for supporting the third rotatable member 11. In this example, two guide slots 12, 12′ are inclined relative to the sliding direction A. The effective areas of the guide slots 12, 12′ thus exert, in both rotational directions of the third rotatable member 11, a forward or reverse sliding force on the first and second members 9, 10. The third rotatable member 11 rotates about a rotational axis as shown at 13 in a direction of arrow B extending in the sliding direction of arrow A, after release of a locking device (not shown). The second displaceable member 10 is displaced to the front toward the head of the seat occupant as shown in FIG. 2B. For example, a prestressed spring 14 displaces the second displaceable member 10.

The driving mechanism 7 also includes a restoring device 16 for returning the second displaceable member 12 to a nominal position 8a from a displaced position 8b. The restoring device includes a handle 18 releasably arranged on a receiver plate 17. The receiver plate 17 is positioned on the first fixed member 9. In this example, a cable 19 may be operatively connected between the handle 18 and third rotatable member 11. An example of a cable is a Bowden cable, and the cable is attached to the handle using a screw connection. Also in this example, a wire portion 20 of the cable 19 is in contact tangentially with an outer surface of the third rotatable member 11. The cable wire 20 is displaced from the sheathing 21 of the cable 19 by rotation of the third rotatable member 11. The handle 18 is displaced with respect to the receiver plate 17. For example, the handle 18 is displaced transversely to the movement of the second displaceable member 10 as shown by arrow C in FIG. 2b. During displacement of the handle 18, a retractable engagement portion projecting from the handle 18 may not yet be engaged by the receiver plate 17. To move the head restraint 4 back into the nominal position 8a, the handle 18 is engaged with the receiver 17 and displaced using a lateral displacement force in the direction of arrow D. The lateral displacement force is transmitted by the cable 19 to the third rotatable member 11, to rotate the third rotatable member back into its initial position, as shown in FIG. 2A, and the locking device reengages. Concurrently, the second displaceable member 10 and the padded sub-section 8 are also returned back into the nominal position 8a.

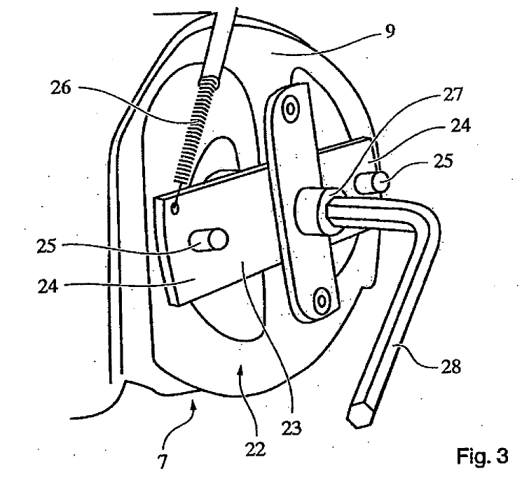

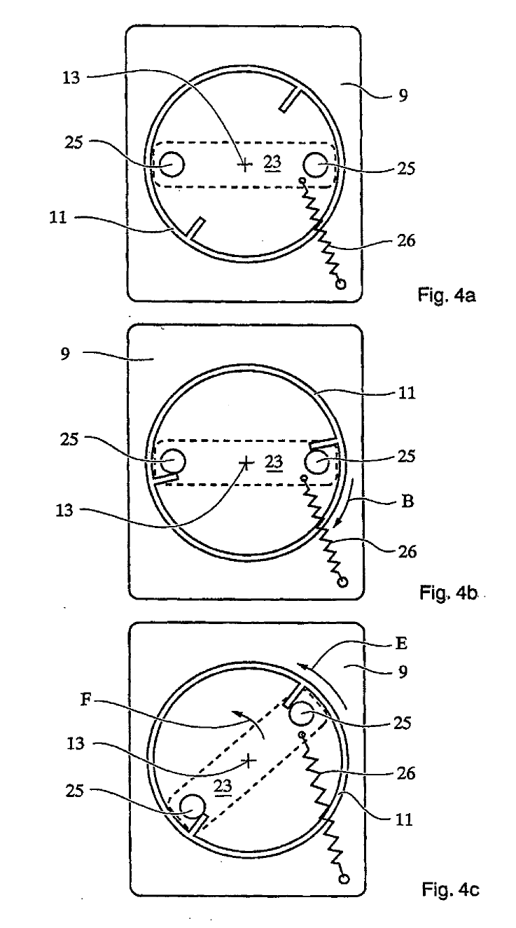

In the example of a head restraint illustrated in FIGS. 3 and 4, the first fixed member 9 is connected to the head restraint base. A swivel lever 23 is connected to a rear face 22 of the first fixed member 9. The swivel lever 23 may rotate independently of the third rotatable member 11 about the same rotational axis 13. An arm portion 24 of the swivel lever 23 extends radially from the rotational axis 13. Each end of the arm 24 may have a pin 25 projecting perpendicular, which projects into the driving mechanism 7, and cooperates with the third rotatable member 11. In this example, the rotational position of the swivel lever 23 may be preset using a tensioned spring 26 in the direction of an end position as shown in FIG. 4A. Upon release of the head restraint 5, such as due to a force, the third rotatable member 11 does not transmit its movement to the swivel lever 23 but only comes into contact with the pin 25 as shown in FIG. 4b for a safety position of the head restraint 5. When the head restraint 5 is displaced, no additional masses are accelerated, which might delay a movement into the safety position. A torque transmitting device, such as a socket 27, or wrench 28, may be used to exert a restoring torque on the swivel lever 23 along the axis 13 in the direction of arrow F as shown in FIG. 4c. This rotational movement applies a tension to the spring 26, that is transmitted by the pin 25, to the third rotational member 11 in the direction arrow E. Once the second displaceable member 10 returns to its initial position, the tool 28 is removed. The spring 26 causes the swivel lever 23 to rotate back to its initial position as shown in FIG. 4A.

The present disclosure has been described as an illustrative manner. It is to be understood that the terminology which has been used is intended to be in the nature of words of description rather than of limitation.

Many modifications and variations of the present disclosure are possible in light of the above teachings. Therefore, the present disclosure may be practiced other than as specifically described.

What is claimed is:

1-10. (canceled)

11. A head restraint for use in a seat, the head restraint having a padded portion that is displaceable relative to a base part of the head restraint from a nominal position to a safety position using a driving mechanism and returnable to the nominal position using a restoring device, the head restraint comprising:
a handle releasably connected to a receiver plate, wherein the receiver plate is positioned on a fixed portion of the base part; and
a cable having one end attached to the handle and an opposed end connected to a rotatable member disposed between the padded portion and the base part, wherein application of a force on the handle that is opposed to a direction of displacement of the padded portion between the nominal position and the safety position, rotates the rotatable member to return the padded portion to the nominal position.

12. The head restraint as set forth in claim 11, wherein the rotatable member has a rotational axis parallel to a direction of displacement of the padded portion, and the rotatable member includes a guide slot that is inclined relative to a direction of displacement of the displacement force during its rotation in a first rotational direction.

13. The head restraint as set forth in claim 12, wherein the restoring device rotates the rotatable member in an opposed rotational direction to the first rotational direction.

14. The head restraint as set forth in claim 13 wherein the force of the restoring device on the rotatable member is tangential to an outer surface of the rotatable member.

15. The head restraint as set forth in claim 11, wherein the cable is a Bowden cable.

16. The head restraint as set forth in claim 11 wherein the handle is fixedly connected to the receiver plate.

17. The head restraint as set forth in claim 11 wherein the handle is positioned on a lower surface of the base part and is displaced in a direction transverse to the direction of movement of the padded portion to actuate the restoring device.

18. The head restraint as set forth in claim 11, wherein the force is a restoring torque applied along the rotational axis of the rotational member.

19. A head restraint for a vehicle having a padded portion that is displaceable relative to a base part of the head restraint between a nominal position and a safety position, the head restraint comprising:
a driving mechanism having a first fixed member connected to the base part, a second displaceable member attached to the padded portion and displaceable with respect to the first fixed member between the nominal position and the safety position, and a third rotatable member rotatably mounted between the first fixed member and the second displaceable member, and rotation of the third rotatable member displaces the second displaceable member between the nominal position and the safety position; and
a restoring device having a handle releasably connected to a receiver plate positioned on the first fixed member and a cable having one end attached to the handle and an opposed end connected to the third rotatable member, wherein application of a force on the handle, that is opposed to a direction of displacement of the second displaceable member between the nominal position and the safety position, returns the padded portion to the nominal position.

20. The head restraint as set forth in claim 19, wherein the third rotatable member has a rotational axis parallel to a direction of displacement of the second displacement member, and the third rotatable member includes a guide slot that is inclined relative to a direction of the displacement force during its rotation in a first rotational direction.

21. The head restraint as set forth in claim 20, wherein the restoring device rotates the third rotatable member in an opposed rotational direction to the first rotational direction.

22. The head restraint as set forth in claim 20 wherein the force of the restoring device on the third rotatable member is tangential to an outer surface of the third rotatable member.

23. The head restraint as set forth in claim 19, wherein the cable is a Bowden cable.

24. The head restraint as set forth in claim 19 wherein the handle is removeably connected to the receiver plate.

25. The head restraint as set forth in claim 19 wherein the handle is positioned on a lower surface of the first fixed member and is displaced in a direction transverse to the direction of movement of the second displaceable member to rotate the third rotatable member.

26. The head restraint as set forth in claim 19, wherein the force is a restoring torque applied along a rotational axis of the third rotational member.

27. A head restraint for a vehicle having a padded portion that is displaceable relative to a base part of the head restraint between a nominal position and a safety position comprising:
a driving mechanism having a first fixed member connected to the base part, a second displaceable member attached to the padded portion and displaceable with respect to the first fixed member between the nominal position and the safety position, and a third rotatable member rotatably mounted between the first fixed member and the second displaceable member, and rotation of the third rotatable member displaces the second displaceable member between the nominal position and the safety position;
a restoring device having a swivel lever connected to a rear surface of the first fixed member, wherein the swivel lever includes a radially extending arm and a pin projecting perpendicular to the arm and the pin cooperatively engages the third rotatable member to restrict rotation of the third rotatable member; and
a torque transmitting device for applying a restoring torque on the swivel lever along an axis of rotation of the third rotatable member to displace the second displaceable member between the nominal position and the safety position and return is the padded portion to the nominal position.

28. The head restraint as set forth in claim 27, wherein the swivel lever rotates the third rotatable member in a direction opposite to the displaceable rotational direction.

29. The head restraint as set forth in claim 27 further comprising a tensioning device for presetting a rotational position of the swivel lever in a nominal position and returning the swivel lever to the nominal position from the safety position.
